(19) United States
(12) Patent Application Publication
(10) Pub. No.: US 2016/0339457 A1
(43) Pub. Date: Nov. 24, 2016

(54) WATER OUTLET VALVE CORE OF A WALL MOUNTED SHOWER HEAD AND WATER OUTPUT DEVICE USING THE SAME

(71) Applicant: Xiamen Runner Industrial Corporation, Xiamen (CN)

(72) Inventor: Lei Hou, Xiamen (CN)

(21) Appl. No.: 15/130,172

(22) Filed: Apr. 15, 2016

(30) Foreign Application Priority Data
May 20, 2015 (CN) 201510258552.7

(51) Int. Cl. B05B 1/32; A61H 1/00; B05B 1/12; A61H 33/00; B05B 1/18; B05B 15/06

(52) U.S. Cl. CPC B05B 1/326; B05B 1/185; B05B 15/061; B05B 1/12; A61H 33/00; A61H 1/008

(57) ABSTRACT

A water outlet valve core of a wall mounted shower head and a water output device each includes an inlet, two outlets, an annular channel, and a flow channel. Water enters the water outlet valve core through the inlet, and most of the water passes through the flow channel and flows out of the outlets. The remaining water passing through the flow channel then enters the annular channel, and is mixed with the most of the water out of the flow channel to flow out of the outlets. Based on concepts of jet switching within a same element, strong water flow and weak water flow switch alternatively to implement the effect of hydro massage, such that conventional rotor-type shower heads won't be easily stuck or worn out to cause loss of massage functions.

### BACKGROUND OF THE INVENTION

1. Field of the Invention

The present invention relates a valve core and, more particularly, to a water outlet valve core of wall mounted shower head.

2. Description of the Related Art

Initially, shower heads used to be just devices for watering flower or plotted plants. Afterwards, shower heads were modified for the purpose of shower, making shower heads a common device in bathroom. Some shower heads can be adjusted to spray different patterns of water, such as massage, gentle spray, strong spray, and intermittent pulse or combination modes.

To provide better massage functions, a type of rotor-type shower heads is employed to spray water jets on body to attain effect of massage. However, as the rotors easily get stuck or wear out, loss of the faucet function may arise.

### SUMMARY OF THE INVENTION

In view of the problems and drawbacks of the conventional techniques, the objective of the present invention is to provide a water outlet valve core of a wall mounted shower head capable of switching strong water flow and weak water flow for the purpose of hydro massage and avoiding the rotors in the shower head getting stuck and being worn out, and a water output device using the water outlet valve core.

To achieve the foregoing objective, the water outlet valve core includes an inlet, two outlets, an annular channel, a flow channel and a protrusion. The inlet is formed in a top of the water outlet valve core.

The two outlets are formed in the bottom of the water outlet valve core.

The annular channel is formed inside the water outlet valve core and communicates with the inlet and the outlets.

The flow channel is conical, is formed inside of the water outlet valve core, is located inside a portion of the water outlet valve core surrounded by the annular channel, and communicates with the inlet, the outlets and the annular channel.

The protrusion is formed on a bottom of the flow channel and is located between the outlets. Preferably, the annular channel takes the form of one of a circle, an oval, a quadrilateral and a pentagon.

Preferably, the annular channel includes two top channels, two bottom channels and two side channels.

The two top channels are defined by a top portion of the annular channel.

The two bottom channels are defined by a bottom portion of the annular channel.

The two side channels are formed between the top channels and the bottom channels, communicate with the respective bottom channels and the respective top channels, and are perpendicularly connected with the respective bottom channels.

Preferably, cross sections of the annular channel and the inlet are rectangular, a width of the inlet is W=1˜3 mm, a length of the inlet is H=3˜4×W, a width of the top channel of the annular channel is B=0.5˜1.5×W, a distance between a top edge of the flow channel and an inner side of the inlet is D=0.4˜1×W, and an angle between an inner side of the flow channel and an inner side of the inlet is a=10°˜15°0

Preferably, the protrusion is trapezoidal, the protrusion has a arced recess, and a slope of two lateral sides of the protrusion is the same as that of an inner wall of the flow channel.

Preferably, water enters the water outlet valve core through the inlet, a first part of water passes through the flow channel and flows out of the outlets, a second part of water being less than the first part of water and passing through the flow channel enters the respective bottom channels and further sequentially passes through the respective side channels and the respective top channels, and is then mixed with the first part of water out of the flow channel to flow out of the respective outlets.

To achieve the foregoing objective, the water output device includes a body, a collar seal, an inner cover, an outer cover and multiple water outlet valve cores.

The collar seal is mounted inside the body to form hermetic seal of the body.

The inner cover is mounted on and covers the collar seal.

The outer cover is mounted on the body to enclose the inner cover, the outer cover between the outer cover and the body.

The multiple water outlet valve cores are mounted between the inner cover and the collar seal. Each water outlet valve core includes an inlet, two outlets, an annular channel, a flow channel and a protrusion.

The inlet is formed in a top of the water outlet valve core.

The two outlets are formed in the bottom of the water outlet valve core.

The annular channel is formed inside the water outlet valve core and communicates with the inlet and the outlets.

The flow channel is conical, is formed inside of the water outlet valve core, is located inside a portion of the water outlet valve core surrounded by the annular channel, and communicates with the inlet, the outlets and the annular channel.

The protrusion is formed on a bottom of the flow channel and is located between the outlets.

Preferably, the annular channel takes the form of one of a circle, an oval, a quadrilateral and a pentagon.

Preferably, the annular channel includes two top channels, two bottom channels and two side channels.

The two top channels are defined by a top portion of the annular channel. The two bottom channels are defined by a bottom portion of the annular channel. The two side channels are formed between the top channels and the bottom channels, communicate with the respective bottom channels and the respective top channels, and are perpendicularly connected with the respective bottom channels.

Preferably, cross sections of the annular channel and the inlet are rectangular, a width of the inlet is W=1˜3 mm, a length of the inlet is H=3˜4×W, a width of the top channel of the annular channel is B=0.5˜1.5×W, a distance between a top edge of the flow channel and an inner side of the inlet is D=0.4˜1×W, and an angle between an inner side of the flow channel and an inner side of the inlet is a=10°˜15°.

The present invention is based on concepts of jet flow within limited space, in which jet flow is a stream of fluid that is ejected into a surrounding flow and exchanges momentum with the surrounding flow to create an entrainment phenomenon. Flow field of the entrained flow is confined by fixed walls of the limited space to cause interference between the fixed walls and the jet flow. To compensate the flow driven away by the entrainment effect, fluid passing through narrow flow paths tends to flow to side portions of the flow paths (hereinafter left side used as an example). According to Bernoulli's principle, if a small volume of fluid is flowing horizontally from a region of high pressure to a region of low pressure, then there is more pressure generated in the rear than in the front. This gives a net force on the volume of the fluid, accelerating the fluid along the streamlines. When water flows into a narrow channel and pressure of the water flow on the left side wall of the channel decreases, jet flow deviates toward the left side wall, and is finally attached to the left side wall to flow. When two side walls of a channel through which a jet flow passes face each other and are symmetrical, the jet will be attached to one of the side walls because of the turbulence from the jet flow itself, and it's called the Coanda effect.

Jet switching is a process that pushes jet flow from one of two side walls to the other side wall. Upon generation of jet flow, some ways are used to increase the pressure in a low-pressure vortex, (backflow effect of fluid is taken as an example), then increase the curvature radius of the jet flow, and further increase the size of the vortex, thereby leading the jet flow to attach to inclined and symmetrical side walls.

The advantages of the water outlet valve core with two outlets reside in water flowing out with different water pressure for implementing the effect of hydro massage, such that conventional rotor-type shower heads won't be easily stuck or worn out to cause loss of massage functions.

### BRIFE DESCRIPTION OF THE DRAWINGS

The detailed description of the drawings particularly refers to the accompanying figures in which:

FIG. 1 is a cross-sectional front view of a water outlet valve core of a wall mounted shower head in accordance with the present invention;

FIG. 2 is a perspective view of the water outlet valve core in FIG. 1;

FIG. 3 is an operational cross-sectional front view of the water outlet valve core in FIG. 1;

FIG. 4 is another operational cross-sectional front view of the water outlet valve core in FIG. 1;

FIG. 5 is a cross-sectional front view showing dimensions in the water outlet valve core in FIG. 1;

FIG. 6 is a cross-sectional side view of a water output device with the water outlet valve core in FIG. 1;

FIG. 7 is an exploded perspective view of the water output device in FIG. 6; and

FIG. 8 is an enlarged perspective view of the water output device in FIG. 6.

### DETAILED DESCRIPTION OF THE INVENTION

The purpose, construction, features, functions and advantages of the present invention can be appreciated and understood more thoroughly through the following detailed description with reference to the attached drawings.

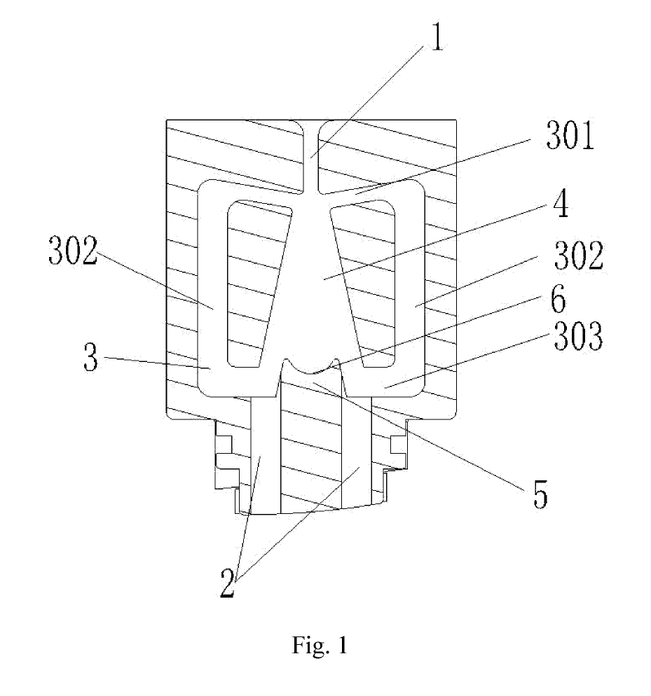

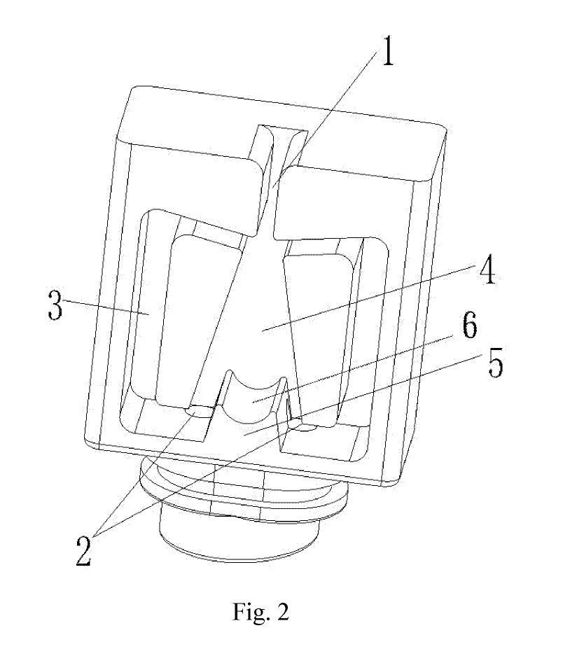

With reference to FIGS. 1 and 2, a water outlet valve core of a wall mounted shower head includes an inlet 1, two outlets 2, an annular channel 3, a flow channel 4 and a protrusion 5. The inlet 1 is formed in a top of the water outlet valve core, the outlets 2 are formed in a bottom of the water outlet valve core, the annular channel 3 is formed inside the water outlet valve core and communicate with the inlet 1 and the outlets 2, and the flow channel 4 is formed inside the water outlet valve core, is located inside a portion of the water outlet valve core surrounded by the annular channel 3, and communicates with the inlet 1, outlets 2 and the annular channel 3. The annular channel 3 includes two top channels 301, two bottom channels 303 and two side channels 302. The top channels 301 are defined by a top portion of the annular channel 3. The bottom channels are defined by a bottom portion of the annular channel 3. The side channels 302 are formed between the top channels 301 and the bottom channels 303 and are perpendicularly connected with the respective bottom channels, and communicate with the respective bottom channels 303 and the respective top channels 301. An end of each top channel connected to the inlet 1 and the flow channel 4 tilts down. The annular channel 3 may take the form of a circle, an oval, a quadrilateral, a pentagon or the like. In the present invention, the annular channel 3 takes the form of a pentagon.

The flow channel 4 is conical.

The protrusion 5 is trapezoidal, is formed on a bottom of the flow channel 4, is located between the outlets 2, and has an arced recess formed on a top surface of the protrusion 5. A slope of two lateral sides of the protrusion 5 is the same as that of an inner wall of the flow channel 4.

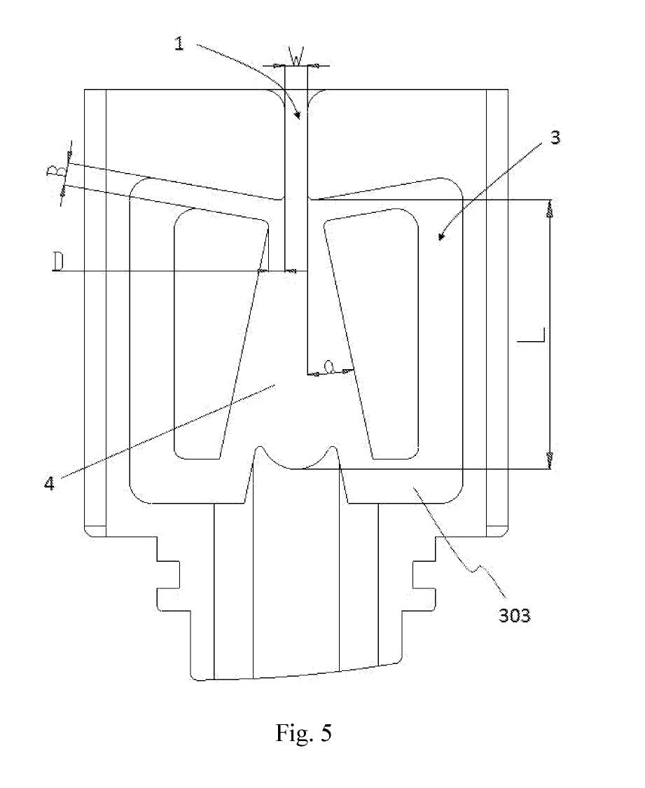

With reference to FIG. 5, cross sections of the annular channel 3 and the inlet are rectangular, a width W of the inlet 1 is W=1˜3 mm, a length H of the inlet 1 is H=3˜4×W, a width of the top channel 303 B of the annular channel 3 is B=0.5˜1.5×W, a distance D between a top edge of the flow channel 4 and an inner side of the inlet 1 is D=0.4˜1×W, and an angle “a” between an inner side of the flow channel 4 and an inner side of the inlet 1 is a=10°˜15°.

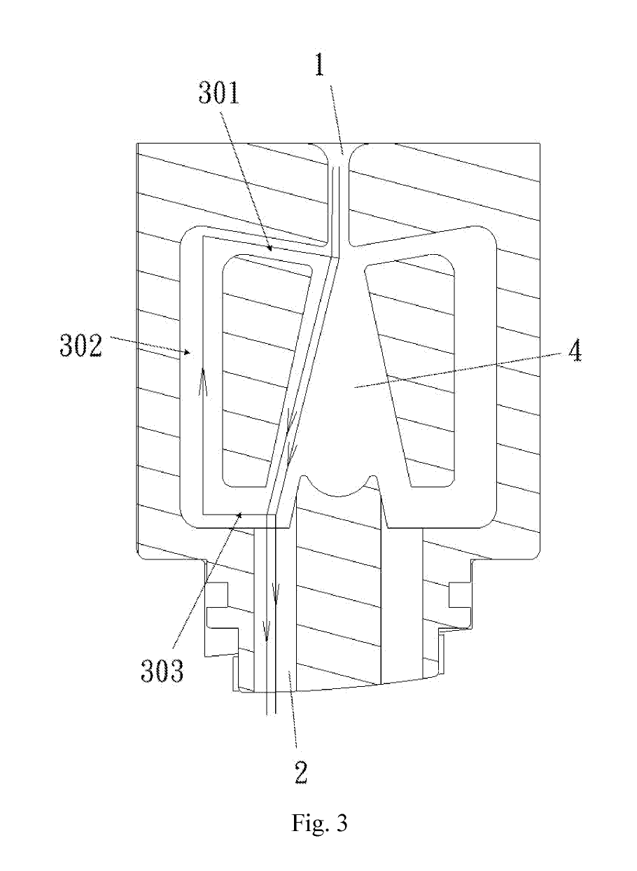

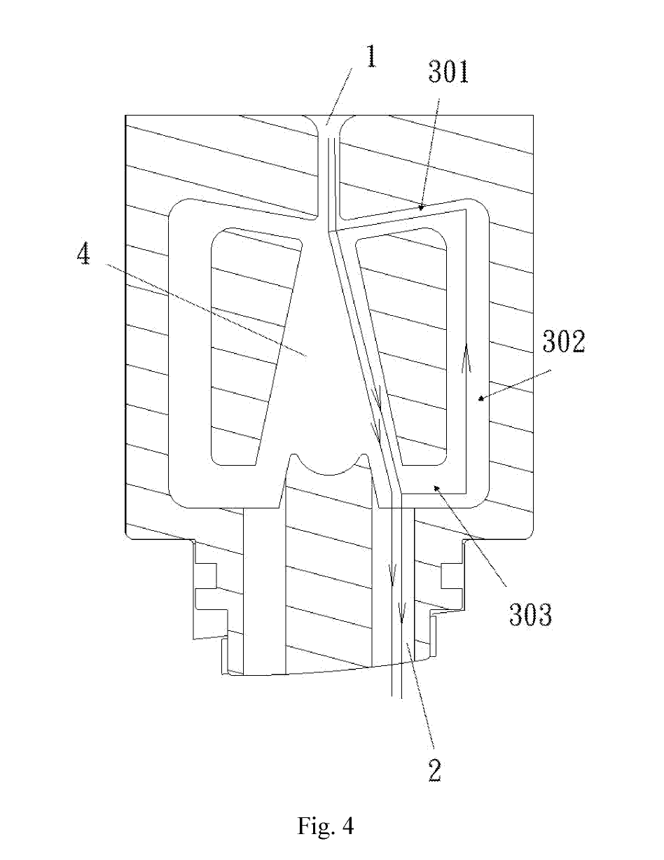

With reference to FIGS. 3 and 4, water enters the water outlet valve core through the inlet 1, and most of the water passes through the flow channel 4 and flows out of the outlets 2. A remaining part of the water passing through the flow channel 4 enters the respective bottom channels 303 and further sequentially passes through the respective side channels 302 and the respective top channels 301, and is then mixed with the most of the water out of the flow channel 4 to flow out of the respective outlets 2.

The present invention is based on concepts of jet flow within limited space, in which jet flow is a stream of fluid that is ejected into a surrounding flow and exchanges momentum with the surrounding flow to create an entrainment phenomenon. Flow field of the entrained flow is confined by fixed walls of the limited space to cause interference between the fixed walls and the jet flow. To compensate the flow driven away by the entrainment effect, fluid passing through narrow flow paths tends to flow to side portions of the flow paths (hereinafter left side used as an example). According to Bernoulli's principle, if a small volume of fluid is flowing horizontally from a region of high pressure to a region of low pressure, then there is more pressure generated in the rear than in the front. This gives a net force on the volume of the fluid, accelerating the fluid along the streamlines. When water flows into a narrow channel and pressure of the water flow on the left side wall of the channel decreases, jet flow deviates toward the left side wall, and is finally attached to the left side wall to flow. When two side walls of a channel through which a jet flow passes face each other and are symmetrical, the jet will be attached to one of the side walls because of the turbulence from the jet flow itself, and it's called the Coanda effect.

Jet switching is a process that pushes jet flow from one of two side walls to the other side wall. Upon generation of jet flow, some ways are used to increase the pressure in a low-pressure vortex, (backflow effect of fluid is taken as an example), then increase the curvature radius of the jet flow, and further increase the size of the vortex, thereby leading the jet flow to attach to inclined and symmetrical side walls.

The water outlet valve core has two outlets 2. Based on jet flow theory, when water flows through the water outlet valve core, 1 jet switching causes high water flow and low water flow to switch so as to attain the effect of hydro massage, such that conventional rotor-type shower heads won't be easily stuck or worn out to cause failure of massage functions.

When water enters the water outlet valve core through the inlet 1, the water passing through the flow channel 4 generates vortex and jet flow because of the blockage of the protrusion 5. The arced recess 6 serves to prevent the protrusion 5 from being worn out by water flow.

### Embodiment 1

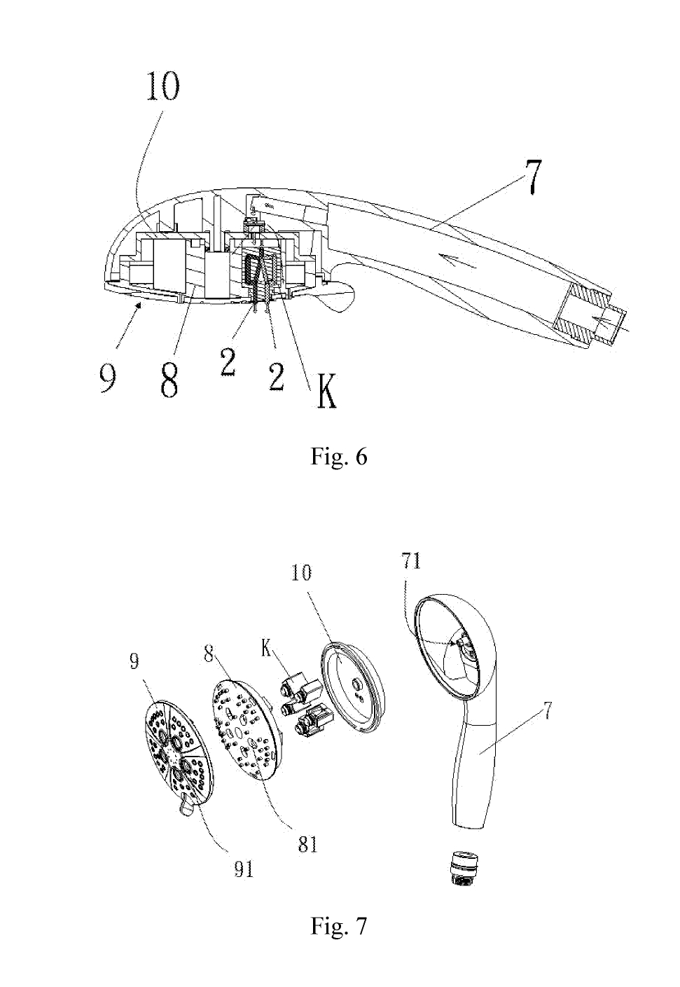

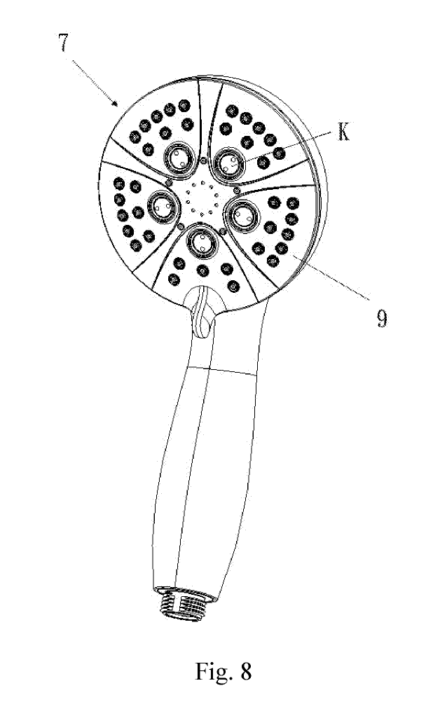

With reference to FIGS. 6 to 8, a water output device in accordance with the present invention includes a body 7, an inner cover 8, an outer cover 9, a collar seal 10 and multiple water outlet valve cores K.

The body 7 has a water inlet 71 communicating with a water hose. The collar seal 10 is mounted inside the body 1 to form hermetic seal of the body 1. The inner cover 8 is mounted on and covers the collar seal 10, and has multiple holes 81 formed through the inner cover 8. The water outlet valve cores K are mounted between the inner cover 8 and the collar seal 10. The outer cover 9 is mounted on the body 1 to enclose the inner cover 8, the multiple water outlet valve cores K and the outer cover 9 between the outer cover 9 and the body 1, and has multiple holes 91 formed through the outer cover 9 and corresponding to the multiple holes 81 of the inner cover 8. The outlets 2 of each water outlet valve core K is directed corresponding holes 81, 91 of the inner cover 8 and the outer cover 9.

What is claimed is:

1. A water outlet valve core comprising:
an inlet formed in a top of the water outlet valve core;
two outlets formed in the bottom of the water outlet valve core;
an annular channel formed inside the water outlet valve core and communicating with the inlet and the outlets;
a flow channel being conical, formed inside of the water outlet valve core, located inside a portion of the water outlet valve core surrounded by the annular channel, and communicating with the inlet, the outlets and the annular channel; and
a protrusion formed on a bottom of the flow channel and located between the outlets.

2. The water outlet valve core as claimed in claim 1, wherein the annular channel takes the form of one of a circle, an oval, a quadrilateral and a pentagon.

3. The water outlet valve core as claimed in claim 1, wherein the annular channel includes:
two top channels defined by a top portion of the annular channel;
two bottom channels defined by a bottom portion of the annular channel; and
two side channels formed between the top channels and the bottom channels, communicating with the respective bottom channels and the respective top channels, and perpendicularly connected with the respective bottom channels.

4. The water outlet valve core as claimed in claim 1, wherein cross sections of the annular channel and the inlet are rectangular, a width of the inlet is W=1˜3 mm, a length of the inlet is H=3˜4×W, a width of the top channel of the annular channel is B=0.5˜1.5×W, a distance between a top edge of the flow channel and an inner side of the inlet is D=0.4˜1×W, and an angle between an inner side of the flow channel and an inner side of the inlet is a=10°˜15°.

5. The water outlet valve core as claimed in claim 1, wherein the protrusion is trapezoidal, the protrusion has an arced recess, and a slope of two lateral sides of the protrusion is the same as that of an inner wall of the flow channel.

6. The water outlet valve core as claimed in claim 1, wherein water enters the water outlet valve core through the inlet, a first part of water passes through the flow channel and flows out of the outlets, a second part of water being less than the first part of water and passing through the flow channel enters the respective bottom channels and further sequentially passes through the respective side channels and the respective top channels, and is then mixed with the first part of water out of the flow channel to flow out of the respective outlets.

7. A water output device comprising:
a body;
a collar seal mounted inside the body to form hermetic seal of the body;
an inner cover mounted on and covering the collar seal;
an outer cover mounted on the body to enclose the inner cover, the outer cover between the outer cover and the body; and
multiple water outlet valve cores mounted between the inner cover and the collar seal, each including:
an inlet formed in a top of the water outlet valve core;
two outlets formed in the bottom of the water outlet valve core;
an annular channel formed inside the water outlet valve core and communicating with the inlet and the outlets;
a flow channel being conical, formed inside of the water outlet valve core, located inside a portion of the water outlet valve core surrounded by the annular channel, and communicating with the inlet, the outlets and the annular channel; and
a protrusion formed on a bottom of the flow channel and located between the outlets.

8. The water output device as claimed in claim 7, wherein the annular channel takes the form of one of a circle, an oval, a quadrilateral and a pentagon.

9. The water output device as claimed in claim 7, wherein the annular channel includes:
two top channels defined by a top portion of the annular channel;
two bottom channels defined by a bottom portion of the annular channel; and
two side channels formed between the top channels and the bottom channels, communicating with the respective bottom channels and the respective top channels, and perpendicularly connected with the respective bottom channels.

10. The water output device as claimed in claim 7, wherein cross sections of the annular channel and the inlet are rectangular, a width of the inlet is W=1˜3 mm, a length of the inlet is H=3˜4×W, a width of the top channel of the annular channel is B=0.5˜1.5×W, a distance between a top edge of the flow channel and an inner side of the inlet is D=0.4˜1×W, and an angle between an inner side of the flow channel and an inner side of the inlet is a=10°˜15°.
